(19) United States
(12) Patent Application Publication
(10) Pub. No.: US 2014/0368198 A1
(43) Pub. Date: Dec. 18, 2014

(54) Insulation Structure For Well Logging Instrument Antennas

(71) Applicant: Schlumberger Technology Corporation, Sugar Land, TX (US)

(72) Inventors: Frank Espinosa, Titusville, NJ (US); Golchehreh Salamat, Sugar Land, TX (US); Bryan Keith Rogers, Spring, TX (US); Tudor Palaghita, Houston, TX (US); Dean M. Homan, Sugar Land, TX (US)

(21) Appl. No.: 14/368,200

(22) PCT Filed: Oct. 5, 2012
(86) PCT No.: PCT/US2012/058951

§ 371 Date: Jun. 23, 2014

Related U.S. Application Data
(60) Provisional application No. 61/578,647, filed on Dec. 21, 2011.

(51) Int. Cl. G01V 3/30; G01V 13/00; E21B 47/12

(52) U.S. Cl. CPC G01V 3/30; E21B 47/122; G01V 13/00
USPC 324/333; 29/600

(57) ABSTRACT

An antenna insulating structure for a well logging instrument includes an antenna bed disposed in a recess formed in an exterior of an instrument mandrel. A feed through port is disposed in the recess and provides a passage between the recess and an atmospheric chamber in the instrument mandrel. An antenna is disposed on the antenna bed and is electrically coupled to the atmospheric chamber through a feedthrough disposed in the port. The port is filled with a sealing material. An antenna cover is disposed on the antenna. At least one of the antenna bed, the sealing material and the antenna cover is made from polyether ether ketone (PEEK) or a composite material thereof.

### BACKGROUND

This disclosure relates generally to the field of electromagnetic well logging instruments. More specifically, the disclosure relates to insulation structures for antennas used on such instruments and methods of making such insulation structures.

Electromagnetic well logging instruments include devices for measuring, for example, electrical conductivity and nuclear magnetic resonance properties of subsurface formations from within a wellbore. Such instruments may include one or more magnetic dipole antennas. Magnetic dipole antennas may have a loop or coil of electrically conductive wire disposed on or proximate the exterior of a sonde mandrel (for instruments conveyed by “wireline” or similar conveyance, or a drill collar (for “logging while drilling [LWD] instruments). Each loop or coil may be disposed to have its respective dipole axis oriented along a selected direction.

The antenna structure may be required to be electrically insulated from fluids in the wellbore, and the antenna structure may be required to exclude fluid under pressure in the wellbore from entering one or more atmospheric pressure chambers defined inside an instrument housing, while providing a passage for antenna wire(s) to enter such chambers for connection to appropriate electronic circuitry therein.

Antenna insulation structures known in the art consist of a composite insulator base that supports the antenna coil disposed between the coil and the exterior surface of the mandrel or collar, a rubber cover to hydraulically seal the antenna, and an epoxy-slurry filled port where the antenna wire connects to a high-pressure resistant electrical feed through connector. For wellbore temperatures exceeding 150 degrees Celsius (° C.), the materials used for antenna insulation structures known in the art have proven inadequate, and as a result there are few reliable electromagnetic well logging instruments operative at wellbore temperatures above such temperature. Challenges to making such instrument include material selection and survival in wellbore environments, mechanical properties of interfaces of different materials at temperatures above 150° C., and process and manufacturing expertise.

There exists a need for reliable electromagnetic well logging instrument antenna insulation structures operative at temperatures above 150° C.

### SUMMARY

One aspect is an antenna insulating structure for a well logging instrument. An antenna insulating structure according to the present aspect includes an antenna bed disposed in a recess formed in an exterior of an instrument mandrel. A feed through port is disposed in the recess and provides a passage between the recess and an atmospheric chamber in the instrument mandrel. An antenna is disposed on the antenna bed and is electrically coupled to the atmospheric chamber through a feedthrough disposed in the port. The port is filled with a sealing material. An antenna cover is disposed on the antenna. At least one of the antenna bed, the sealing material and the antenna cover is made from polyether ether ketone (PEEK) or a composite material thereof

Other aspects and advantages of the invention will be apparent from the description and claims which follow.

### BRIEF DESCRIPTION OF THE DRAWINGS

FIG. 1 shows an example multiaxial electromagnetic well logging instrument disposed in a wellbore drilled through subsurface formations.

FIG. 2 shows an example wellbore imaging instrument disposed in a wellbore drilled through subsurface formations.

FIG. 3 shows an example of an antenna geometry wherein PEEK is used as the coil bed support material.

FIG. 4 shows an illustration of a drill collar with a recess for an antenna for an LWD well logging instrument.

FIG. 5 shows the surface of the collar being physically prepared by sand/grit blasting or mechanical keying. Then the surface is coated with virgin PEEK and melt bonded to the collar surface.

FIG. 6 shows glass-filled PEEK towpreg or prepreg weave applied to the structure shown in FIG. 4. In this case, PEEK may be melt bonded to the collar, built up, and a antenna coil groove machined into the PEEK.

FIG. 7 shows an antenna coil wire wound onto the coil groove of FIG. 6.

FIG. 8 shows a feed-through port and coil wire filled with high temperature epoxy and cured, filling all gaps, spaces and voids. A rubber cover may be externally molded thereon.

FIG. 9 shows the feed-through ports and coil wires filled with high temperature rubber, molded in place.

FIGS. 10A through 10E show various views of an example of a coil bed being made from a PEEK based composite.

FIGS. 11A through 11E show various views of a coil bed and coil overlay being made from a PEEK based composite.

FIG. 12 shows an example of a coil bed, overlay and seal cover all being made from a PEEK based composite, each of which may have a different PEEK/fiber fill ratio.

### DETAILED DESCRIPTION

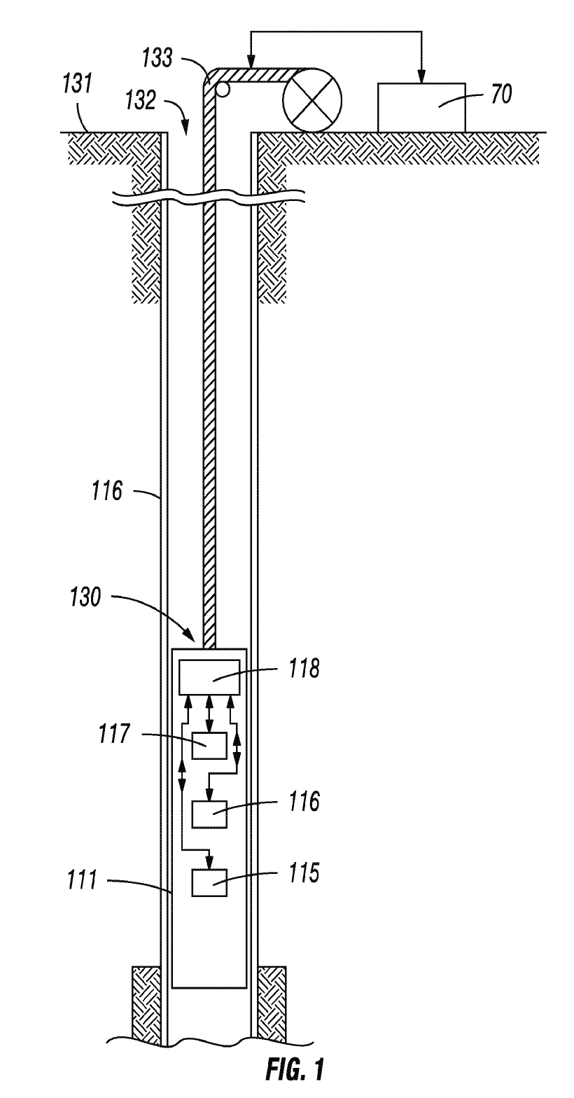

FIG. 1 shows an example electromagnetic well logging instrument 130. The measurement components of the instrument 130 may be disposed in a housing 111 shaped and sealed to be moved along the interior of a wellbore. The well logging instrument 130 may, in a form hereof, be of a type sold under the trademark RT SCANNER, which is a trade mark of Schlumberger Technology Corporation, Sugar Land, Tex.

The instrument housing 111 may contain a multiaxial transmitter 115, and two or more multiaxial receivers 116, 117 at different axial spacings from the transmitter 115. The transmitter 115, when activated, may emit a continuous wave electromagnetic field at one or more selected frequencies. Shielding (not shown) may be interposed between the transmitter 115 and the axially closest receiver (e.g., 116) to reduce the effects of direct electromagnetic communication between the transmitter 115 and the receivers 116, 117. The detectors 116, 117 may be multi-axis wire coils each coupled to a respective receiver circuit (not shown separately). Thus, detected electromagnetic energy may be characterized at each of a plurality of distances from the transmitter 115.

The transmitter 115 and receivers 116, 117 may be triaxial wherein an axis of one of the magnetic dipoles of one of the collocated antennas may be oriented along the longitudinal axis of the instrument, and two other dipole moment axes may be mutually orthogonally oriented to the foregoing dipole moment axis. It will be appreciated by those skilled in the art that different numbers of antennas having dipole moments oriented along other directions may be used to equal effect provided that there are sufficient numbers of such antennas.

The instrument housing 111 maybe coupled to an armored electrical cable 133 that may be extended into and retracted from the wellbore 132. The wellbore 132 may or may not include metal pipe or casing 116 therein. The cable 133 conducts electrical power to operate the instrument 130 from a surface 131 deployed recording system 70, and signals from the detectors 116, 117 may be processed by suitable circuitry 118 for transmission along the cable 133 to the recording system 70. The recording system 70 may include a computer as will be explained below for analysis of the detected signals as well as devices for recording with respect to depth and/or time the signals communicated along the cable 133 from the instrument 130. Those skilled in the art will recognize that the instrument shown in FIG. 1A may also be configured to be conveyed by a drill string used to drill the wellbore 132, and thus form part of a logging while drilling (“LWD”) instrument. Such LWD instruments may include devices therein for recording signals detected by the various sensors and detectors in the instrument, and may include a communication subsystem for transmitting some or all of such signals to the recording unit 70 at the surface, for example, by modulating pressure of drilling fluid pumped into the drill string. The cable conveyance shown in FIG. 1 is therefore not to be construed as a limit on the scope of the present disclosure.

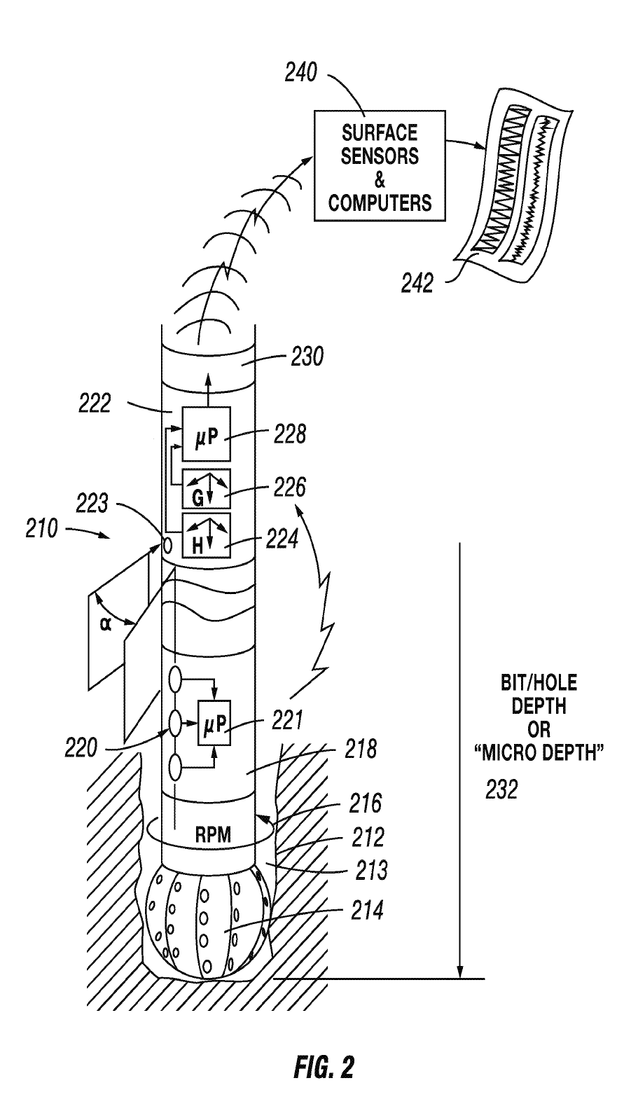

FIG. 2 shows a non-limiting example wellbore imaging instrument, for example, an instrument as described more fully in U.S. Pat. No. 5,519,668 issued to Montaron and incorporated herein by reference for imaging a wellbore wall while a wellbore is being drilled. One possible embodiment of a drill string 210 containing devices for acquiring and transmitting data for constructing a real-time image of the formation surrounding the borehole according to the invention. The drill string 210 penetrates the formation 212 as a drill bit 214 rotates in the direction shown by arrow 216. Although it is possible to rotate the drill bit 214 without also rotating the drill string 210, for purposes of the present example, it is the rotation of the drill string 210 which is important. As the drill string 210 rotates, several components located above the bit 214 take measurements regarding the formation 212 around the wellbore 213 and the angular orientation of the drill string 210. In particular, a resistivity sensor 28 may be provided with one or more resistivity buttons 220 which measure the resistivity of the formation 212 at the point where the button 220 faces the wall of the wellbore 213. The resistivity button 220 is coupled to a processor 221 for processing resistivity measurements to obtain an image as explained in the Montaron patent. In addition to the resistivity sensor 218, a position sensor 222 is provided with a magnetic field sensor (three axis magnetometer) 224 and a gravity sensor (three axis accelerometer) 226, both of which are coupled to a processor 228. As known in the art, the processor 228 combines three-dimensional magnetic and gravitational data from the magnetic field sensor 224 and gravity sensor 226 to provide toolface (instrument rotational index) data. As mentioned above, the toolface is the instantaneous angular position of a point (e.g. the slick pin 223) on the surface of the drill string as the drill string 210 rotates. Thus, in one rotation of the drill string, the toolface will change from 0 to 360 degrees and then repeat this scale during the next rotation of the drill string. The drill string 210 may also provided with a mud pulse telemetry component 230 for transmitting data to the surface processors 240 at the surface for creating images and logs 242. As the drill string 210 rotates, the resistivity button 220 on the resistivity sensor 218 is capable of taking many rapid measurements of the resistivity of the formation 212 around the wellbore 213. The resistivity measurements are indicative of the type of formation (mineral and porosity) present around the wellbore, e.g., sand, clay, lignite, montmorillonite, water, bound water, gas, oil, etc., each of which have a different resistivity, typically in the range of 0.2 to 2,000 ohm-meters. As shown in FIG. 2, the resistivity sensor 218 may be fixed relative to the position sensor 222 so that both sensors rotate together. The resistivity button 220 may be angularly offset from the slick pin 223 by a known angle [α] so that by knowing the toolface angle of the slick pin 223, the toolface of the resistivity button 220 is also known. The depth 232 of the resistivity sensor 218 may be computed at the surface using methods such as those taught in U.S. Pat. No. 4,843,875, incorporated herein by reference. As with the example induction instrument shown in FIG. 1A, the example imaging instrument shown in FIG. 1B may be conveyed through the wellbore other than on a drill string. For example and without limitation, the imaging instrument may be conveyed by electrical cable (“wireline”).

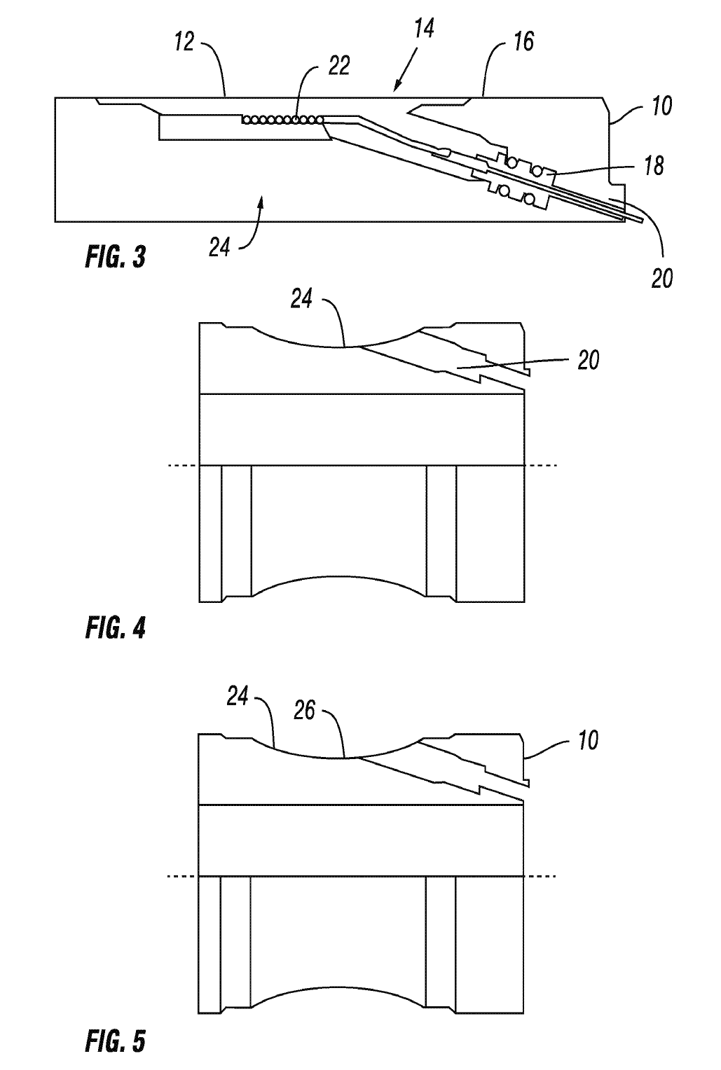

Having explained in general terms electromagnetic induction well logging, example antenna structures will now be explained with reference to FIGS. 3 through 12.

Polyether ether ketone (PEEK) is a colorless organic polymer thermoplastic that is used in engineering applications. PEEK is a semicrystalline thermoplastic with excellent mechanical and chemical resistance properties that are retained to high temperatures. PEEK's Young's modulus is 3.6 GPa and its tensile strength is about 90 to 100 MPa. PEEK has a glass transition temperature around 143 ° C. (289 ° F.) and melts at around 343 ° C. (662 ° F.). It is highly resistant to thermal degradation as well as attack by both organic (non-polar and polar) solvents and aqueous materials. PEEK has been used in wellbore tools and instrumentation for a considerable time.

There have been some studies on the properties of PEEK by companies such as Vitrex (Gems 101012810) and ADC. PEEK has a demonstrated utility in wellbore tools and instruments at continuous service temperatures above 200 C.

In various examples of a well logging instrument antenna structure, PEEK and/or PEEK composites may be used in various parts of the antenna insulating structure, including one or more of the following components: the coil bed; antenna wire port filler; overlay and/or hydraulic seal layer on the antenna. PEEK or composites made from PEEK may be used to replace any or all of the composite materials and/or rubber used in antenna insulation structures known in the art for well logging instruments.

An example antenna and insulation structure is shown in FIG. 3. An instrument mandrel 10, which for “wireline” or similarly conveyed instrument may be a metal or other material “sonde” (see FIG. 1) and which for logging while drilling (LWD) instruments (see FIG. 2) may be a drill collar or similar structure connectable to a drill string may include an antenna recess 24 formed into an exterior surface thereof. An antenna 22, which may be a loop or coil of insulated electrical wire, may be disposed in the antenna recess 24. The dipole orientation of the antenna 22 is not a limit on the scope of the invention; the example in FIG. 3 is only meant to illustrate an insulation structure and not to define any particular dipole orientation of the antenna 22. A feed through port 20 may be formed between the antenna recess 24 and an interior of the mandrel 10, wherein the mandrel may define one or more sealed, atmospheric chambers (not shown separately). Such chambers (not shown) may include suitable electronic circuitry (not shown) to connect to the antenna 22 depending on the type of well logging instrument. Typically the antenna 24 will be electrically connected to the circuitry (not shown) through a high pressure resistant feed through connector 18. The feed through connector 18 may be any type known in the art, for example, such as those sold by Kemlon Products, Pearland, Tex. Feed through port filler 16 may be disposed in the feed through port 20 externally to the feed through connector 18. A coil supporting structure or “bed” 12 may be made from electrically insulating material and may provide a mechanical support for the underside of the antenna 22 so that it retains its shape as the mandrel 10 is exposed to high pressures and temperatures in a typical wellbore (not shown) during operation of the well logging instrument. An antenna cover 14 may be applied to the exterior of the antenna 22 and the bed 14 to provide abrasion resistance and to hydraulically seal the antenna 22 and the port 20 from fluid under pressure in the wellbore during use of the well logging instrument. As will be explained below, any or all of the foregoing antenna insulating structure components, e.g., the antenna bed 12, the port filler 16, and the antenna cover 14 may be made from PEEK or composites thereof.

A process for making an insulated antenna for a well logging instrument using materials according to the various aspects of the invention will be explained with referenced to FIGS. 4 through 9. In FIG. 4, the bare mandrel 10 is shown, wherein on the exterior surface thereof may be formed the antenna recess 24 and the feed through port 20. The exterior surface of the antenna recess 24 may be prepared by, for example, sand/grit blasting or mechanical keying. In some examples, after such preparation and with reference to FIG. 5, the surface of the antenna recess 24 may then be coated with PEEK or a composite material made therewith. The PEEK or composite thereof may be coated by heating the PEEK above the melting point and allowing the melted PEEK or composite to settle in the antenna recess 24.

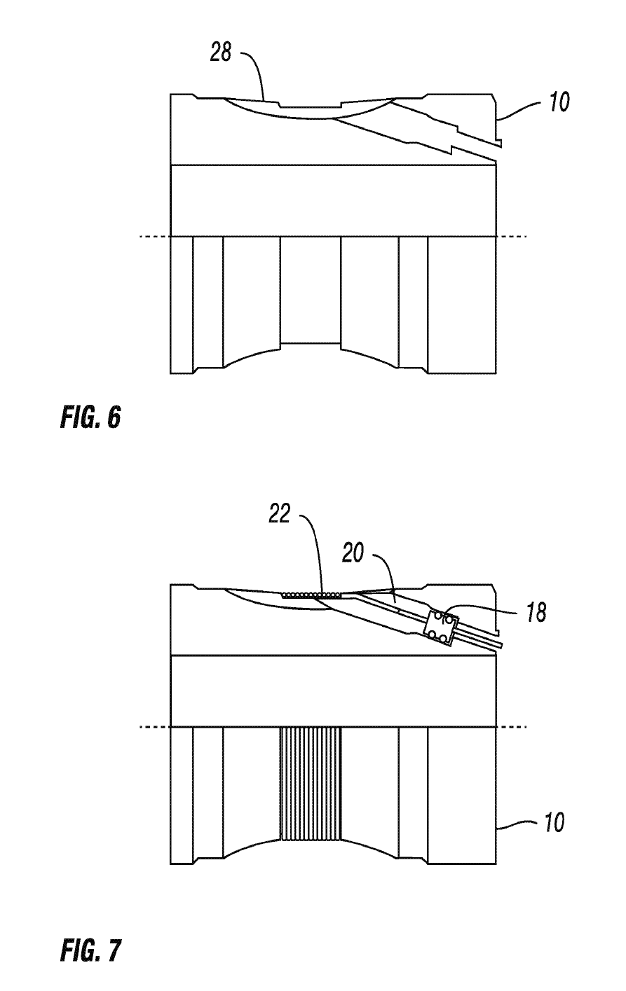

In FIG. 6, PEEK or composite made therewith may be applied to the exterior of the coated surface of FIG. 5 to build up the antenna bed (12 in FIG. 1), shown in unfinished form in FIG. 6 as a bed form 28. The bed form 28 may be made from towpreg (a prepreg fabricated from tow which can be converted to woven and braided fabric) or prepreg fiber-filled PEEK. The fiber may be, for example and without limitation, glass fiber or other electrically non-conducting organic fiber. The fibers in the bed form 28 may be placed at selected axial and radial orientations and selected PEEK-to-fiber ratios for the composite material to provide suitable mechanical properties for the bed form 28. The bed form 28 may be applied to the instrument mandrel 10 by heating the PEEK above its melting temperature. The bed form 28 may be finish machined after the PEEK is allowed to cool and harden.

In FIG. 7, the antenna 22 may be applied to the finished bed form 28, and part of the antenna wire may be inserted into the feed through port 20. The antenna wire may be coupled to the exterior terminal(s) of the feed through 18.

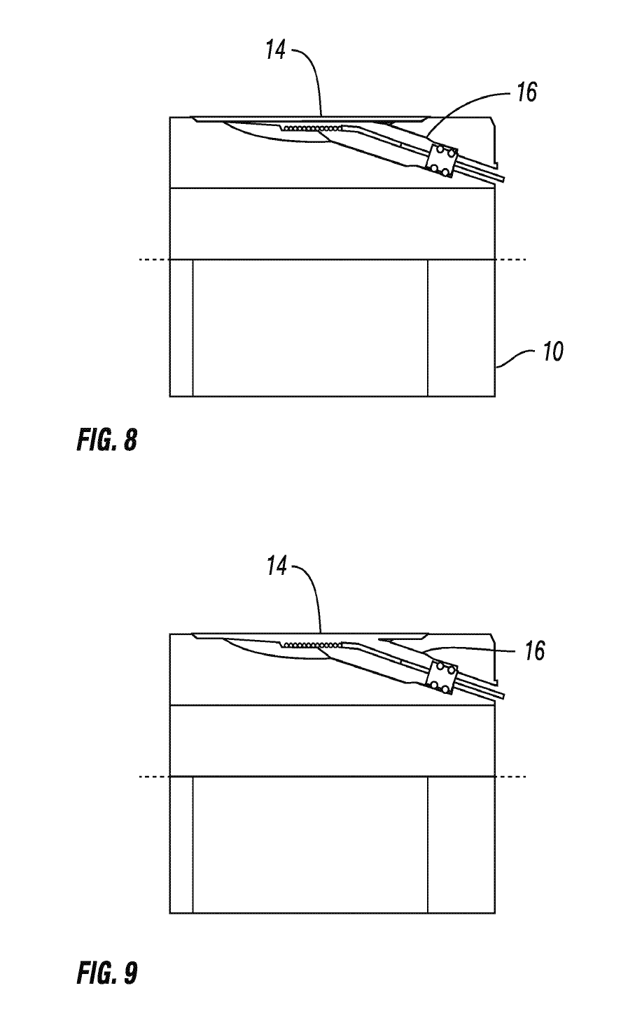

In FIG. 8, the port fill 16 and the antenna cover 14 may be applied. In the example of FIG. 8, the port fill 16 may be a high temperature resistant epoxy. The port fill 16 may fill all voids, gaps and spaces in the antenna 22, the port 20 and adjacent structures. The antenna cover 14 may be high temperature resistant rubber (e.g., fluoroelastomer or perfluoroelastomer), molded in place.

FIG. 9 shows another example of the completed antenna insulation structure wherein both the port fill 16 and the antenna cover 14 may be high temperature rubber molded in place.

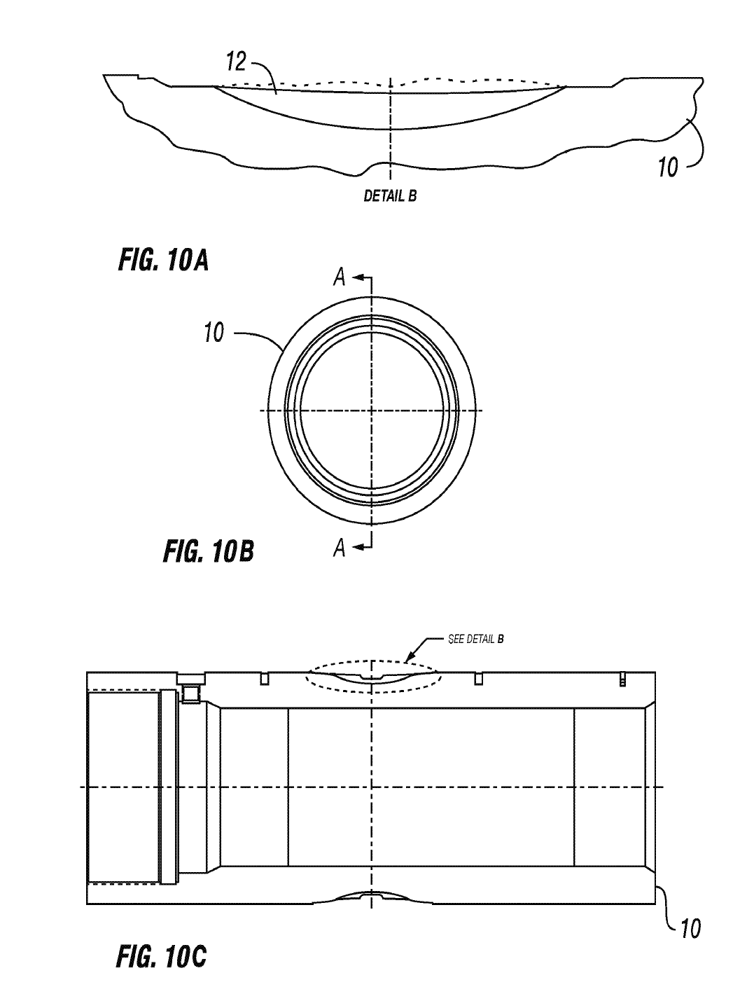

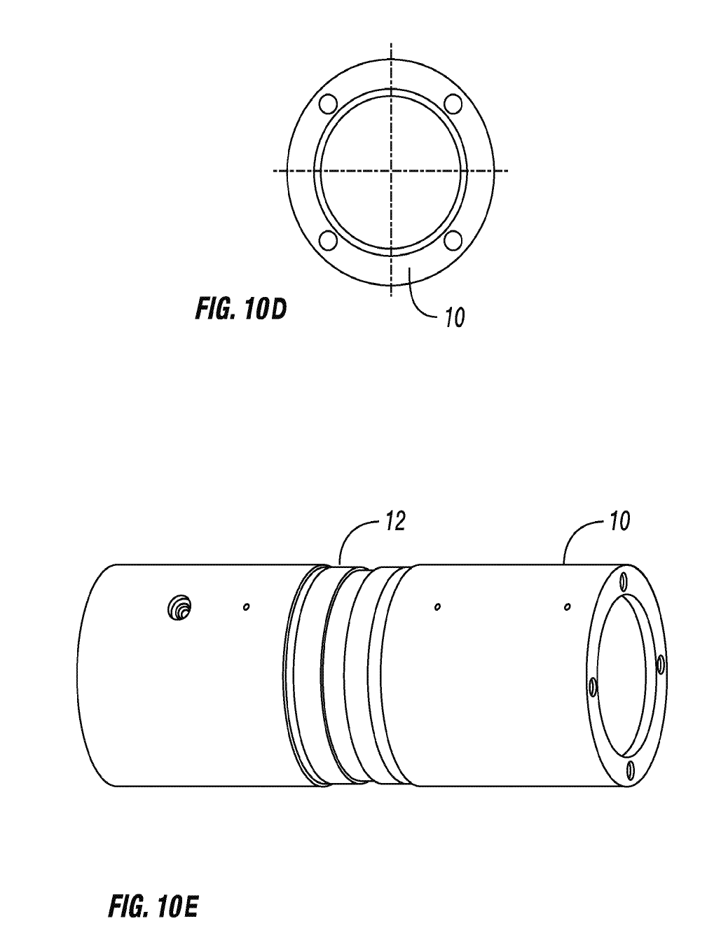

FIGS. 10A through 10E show various views of the instrument mandrel 10 and the antenna bed 12, wherein the antenna bed 12 may be made from PEEK composite material as described above with reference to FIG. 6.

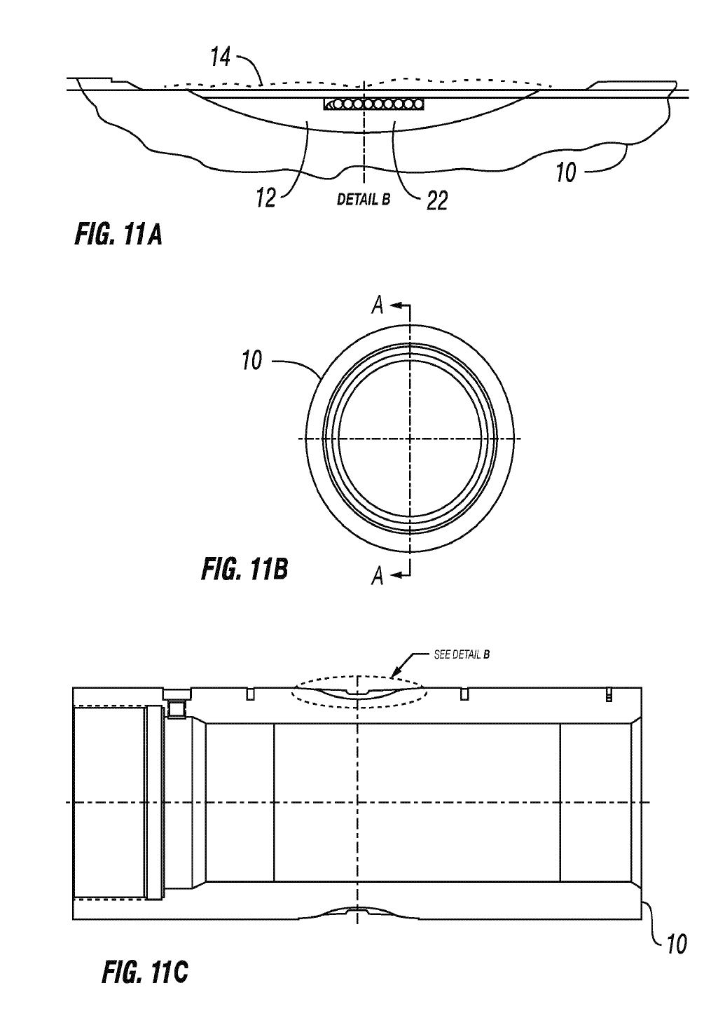

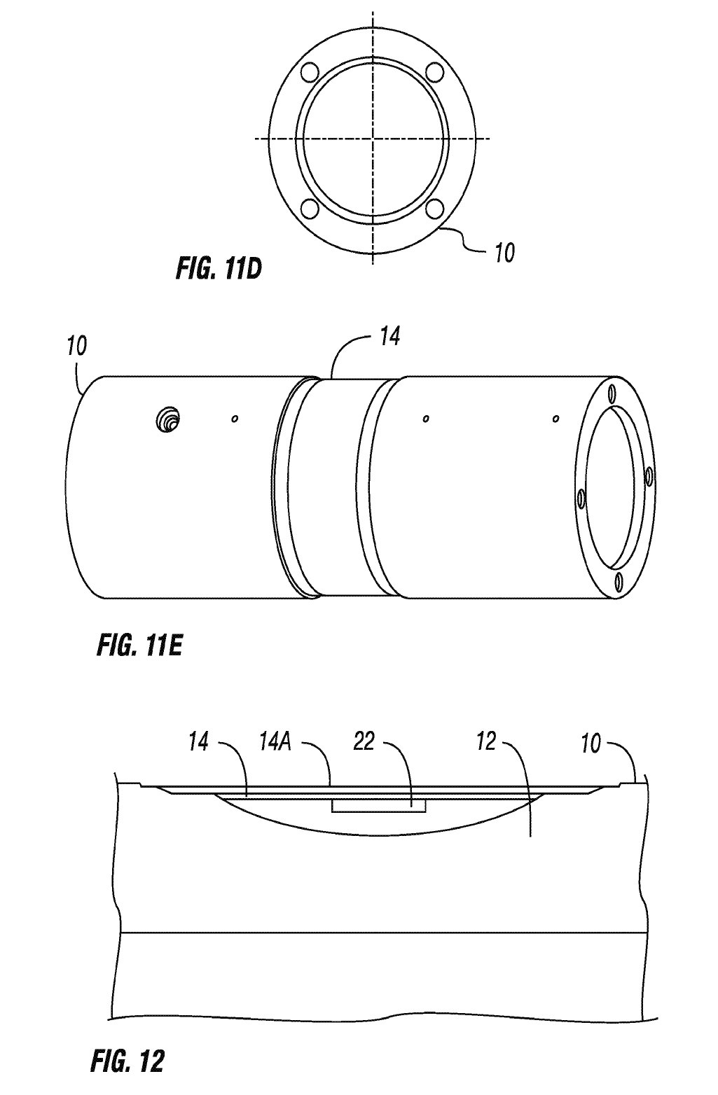

FIGS. 11A through 11E show various views of the instrument mandrel, antenna bed 12, antenna 22 and the antenna cover 14 wherein the antenna bed 12 and the antenna cover 14 may both be made from various forms of PEEK composite as explained with reference to FIG. 6. As will be appreciated by those skilled in the art, the fiber orientation and PEEK to fiber fill ratio for the composites used in each of the antenna bed 12 and the antenna cover 14 may be different and selected to have suitable mechanical properties as used for the respective components.

FIG. 12 shows a cross sectional view of an example of the coil bed 12, a coil overlay 14 and seal cover 14A all being made from a PEEK based composite. The foregoing components can each have a different PEEK/glass fill ratio and fiber orientation, as explained above.

Well logging instrument antenna insulating structures made according to the various examples shown herein may provide electromagnetic well logging capability for use at higher temperatures and pressures than are possible using antenna insulating structures known in the art.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An antenna insulating structure for a well logging instrument, comprising:
an antenna bed disposed in a recess formed in an exterior of an instrument mandrel;
a feed through port disposed in the recess and providing a passage between the recess and an atmospheric chamber in the instrument mandrel;
an antenna disposed on the antenna bed, the antenna electrically coupled to the atmospheric chamber through a feedthrough disposed in the port, the port filled with a sealing material; and
an antenna cover disposed on the antenna, wherein at least one of the antenna bed, the sealing material and the antenna cover is made from polyether ether ketone (PEEK) or a composite material thereof.

2. The insulating structure of claim 1 wherein the composite material has a fiber disposed in the PEEK, a ratio of PEEK to fiber selected to provide mechanical properties corresponding to the one of the antenna cover sealing material and antenna bed made therefrom.

3. The insulating structure of claim 2 wherein the fiber comprises at least one of glass and electrically non-conducting organic fiber.

4. The insulating structure of claim 1 wherein the composite material has a fiber disposed in the PEEK, an orientation of the fiber selected to provide mechanical properties corresponding to the one of the antenna cover sealing material and antenna bed made therefrom.

5. The insulating structure of claim 4 wherein the fiber comprises at least one of glass and electrically non-conducting organic fiber.

6. A method for forming an electromagnetic antenna on a mandrel, comprising:
forming a recess in an exterior surface of the mandrel;
forming a feed through port between an exterior of the mandrel and an interior thereof proximate the recess;
forming an antenna bed in the recess;
forming an antenna in the antenna bed;
electrically coupling the antenna to a feed through connector disposed in the feed through port;
filling the feed through port with a sealing material; and
disposing a cover on the antenna, wherein at least one of the antenna bed, the sealing material and the antenna cover is made from polyether ether ketone (PEEK) or a composite material thereof.

7. The method of claim 6 wherein the composite material has a fiber disposed in the PEEK, a ratio of PEEK to fiber selected to provide mechanical properties corresponding to the one of the antenna cover sealing material and antenna bed made therefrom.

8. The method of claim 7 wherein the fiber comprises at least one of glass and electrically non-conducting organic fiber.

9. The method of claim 6 wherein the composite material has a fiber disposed in the PEEK, an orientation of the fiber selected to provide mechanical properties corresponding to the one of the antenna cover sealing material and antenna bed made therefrom.

10. The method of claim 9 wherein the fiber comprises at least one of glass and electrically non-conducting organic fiber.

11. An electromagnetic well logging instrument, comprising:
a sonde mandrel configured to be moved through a wellbore drilled through subsurface formations;
an antenna bed disposed in a recess formed in an exterior of the mandrel;
a feed through port disposed in the recess and providing a passage between the recess and an atmospheric chamber in the instrument mandrel;
an antenna disposed on the antenna bed, the antenna electrically coupled to the atmospheric chamber through a feedthrough disposed in the port, the port filled with a sealing material;
electrical circuits connected to the antenna to enable at least one of emission of electromagnetic energy and detection of electromagnetic energy by the antenna;
an antenna cover disposed on the antenna, wherein at least one of the antenna bed, the sealing material and the antenna cover is made from polyether ether ketone (PEEK) or a composite material thereof.

12. The electromagnetic well logging instrument of claim 11 wherein the composite material has a fiber disposed in the PEEK, a ratio of PEEK to fiber selected to provide mechanical properties corresponding to the one of the antenna cover sealing material and antenna bed made therefrom.

13. The electromagnetic well logging instrument of claim 12 wherein the fiber comprises at least one of glass and electrically non-conducting organic fiber.

14. The electromagnetic well logging instrument of claim 11 wherein the composite material has a fiber disposed in the PEEK, an orientation of the fiber selected to provide mechanical properties corresponding to the one of the antenna cover sealing material and antenna bed made therefrom.

15. The electromagnetic well logging instrument of claim 14 wherein the fiber comprises at least one of glass and electrically non-conducting organic fiber.

16. The electromagnetic well logging instrument of claim 11 wherein the sonde mandrel comprises a wireline conveyance mandrel.

17. The electromagnetic well logging instrument of claim 11 wherein the sonde mandrel comprises a drill collar.

18. A method for well logging, comprising:
moving a sonde mandrel through a wellbore drilled through subsurface formations, wherein the sonde mandrel comprises, an antenna bed disposed in a recess formed in an exterior of the mandrel. a feed through port disposed in the recess and providing a passage between the recess and an atmospheric chamber in the instrument mandrel, an antenna disposed on the antenna bed, the antenna electrically coupled to the atmospheric chamber through a feedthrough disposed in the port, the port filled with a sealing material, electrical circuits connected to the antenna to enable at least one of emission of electromagnetic energy and detection of electromagnetic energy by the antenna, an antenna cover disposed on the antenna, wherein at least one of the antenna bed, the sealing material and the antenna cover is made from polyether ether ketone (PEEK) or a composite material thereof; and
energizing the circuits to at least one of emit electromagnetic energy into the formations and receive electromagnetic energy from the formation through the antenna.

19. The method of claim 18 wherein the composite material has a fiber disposed in the PEEK, a ratio of PEEK to fiber selected to provide mechanical properties corresponding to the one of the antenna cover sealing material and antenna bed made therefrom.

20. The method of claim 19 wherein the fiber comprises at least one of glass and electrically non-conducting organic fiber.

21. The method of claim 18 wherein the composite material has a fiber disposed in the PEEK, an orientation of the fiber selected to provide mechanical properties corresponding to the one of the antenna cover sealing material and antenna bed made therefrom.

22. The method of claim 21 wherein the fiber comprises at least one of glass and electrically non-conducting organic fiber.

23. The method of claim 18 wherein the moving the sonde mandrel comprises extending and/or retracting a cable from a winch.

24. The method of claim 18 wherein the moving the sonde mandrel comprising moving a pipe string within the wellbore.
